(19) United States
(12) Patent Application Publication
(10) Pub. No.: US 2006/0020968 A1
(43) Pub. Date: Jan. 26, 2006

(54) Method for commercialization and advertising using a personal media player

(75) Inventors: Mitchell Kroll, Solon, OH (US); Lauren Spilman, Moreland Hills, OH (US); Steven Spilman, Moreland Hills, OH (US); Blake Squires, Akron, OH (US); Christopher Celeste, Shaker Heights, OH (US)

Correspondence Address: BAKER & HOSTETLER LLP, Washington Square, Suite 1100, 1050 Connecticut Avenue, N.W., WASHINGTON, DC, 20036, US

(73) Assignee: Findaway World LLC

(21) Appl. No.: 10/975,534

(22) Filed: Oct. 29, 2004

Related U.S. Application Data
(60) Provisional application No. 60/590,364, filed on Jul. 23, 2004.

(51) Int. Cl. H04N 5/445; G09B 25/00

(52) U.S. Cl. 725/37; 434/365

(57) ABSTRACT

Methods for disseminating a portable, pre-configured, self-contained media player with non-removable, non-rerecordable digital content is provided. By binding the content to a portable and inexpensive media player, enhanced dissemination of the content, whether in audio and/or video form, to consumers can be achieved. Due to the portability and “instant-on” capability of a self-contained media player, consumers can be more effectively targeted with advertising or event-related information. Due to the non-removability of the content in the media player, the content provider's concerns regarding copying of the content can be minimized.

This application claims priority to provisional U.S. patent application entitled “Personal Media Player and Method for Use Thereof,” filed Jul. 23, 2004, having a Ser. No. 60/590,364, the disclosure of which is hereby incorporated by reference in its entirety.

### FIELD OF THE INVENTION

The present invention relates generally to methods for using a portable personal media player. More particularly, the present invention relates to the use of a portable digital media player having a fixed, pre-loaded content for advertising, commercialization, informational, and entertainment based products and venues.

### BACKGROUND OF THE INVENTION

Conventional approaches to audio and visual media are primarily focused on providing entertainment to the consumer. To facilitate this objective, entertainment related industries have developed a diverse inventory of electronic devices that provide a mechanism for the consumer to enjoy the entertainment. Such examples are, of course, televisions, radio, CD players, portable video/audio recorders and players. However, all of the media/entertainment playing devices are presumed to be a consumer purchased item, separate from the content or the media placed therein. Therefore, to use the player, the consumer must first separately purchase the media/content and place it into the media player for playback.

Since the media is separate from the player, control of how the media is played or viewed by the consumer is dependent on the capability and quality of the consumer's player. Also, with the advent of digitally coded content and the ease of communicating digital information, copyright protection of the content has become an ever increasing concern in the entertainment industry. Therefore, there has been herethereto no satisfactory mechanism for preventing the unauthorized copying of digital entertainment or information stored on a media.

It is recognized that entertainment has within it secondary or consumer influence attributes such as advertising, cross marketing, or branding, when used in addition to the entertainment. The full potential of the secondary value is compromised by the fact that the vendor-provided entertainment is often experienced in a surrounding that is disassociated from the vendor's venue. For example, the media containing the entertainment (e.g., CD, tape) is typically sold in a packaged form that does not allow the consumer to enjoy the purchase “on-site.” Thus, secondary value, such as tying the music or performance on the media to an event or promotion at the vendor's venue cannot be exploited.

Therefore, there has been a longstanding need in the entertainment/information industry for systems and methods that facilitate the use of the desired media/information by the consumer when maximally appropriate to the commercial purposes of the media provider, and also provide a degree of copyright protection.

### SUMMARY OF THE INVENTION

The foregoing needs are met, to a great extent, wherein in accordance with one embodiment of the present invention, a method of distributing content is provided, comprising the steps of, storing the content in a digitized format in a fixed memory of a portable, self-contained, playback-only media player, wherein the memory is non-consumer recordable and the digitized content is non-transferable from the player.

In accordance with another embodiment of the present invention, a method of distributing content, is provided, comprising the steps of, sponsoring an activity which solicits at least one or more attendees, and distributing the content to an attendee in a portable, self-contained, playback-only media player, wherein the content is digitally stored in a fixed memory of the player, and the memory is non-consumer recordable, and the digitized content is non-transferable from the player.

In accordance with yet another embodiment of the present invention, a method of distributing content is provided, comprising the steps of, providing a product, bundling with the product a portable, self-contained, playback-only media player, containing product-related content digitally stored in a fixed memory of the player, wherein the memory is non-consumer recordable, and the digitized content is non-transferable from the player.

In accordance with yet another embodiment of the present invention, a method of distributing content is provided, comprising the steps of, displaying a portable, self-contained, playback-only media player, containing content stored in a digitized format in a fixed memory of the player, wherein the memory is non-consumer recordable, and the digitized content is non-transferable from the player, and at least renting or selling the player to a consumer.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of an exemplary media player according to this invention.

FIG. 2 is an illustration depicting one of several exemplary methods according to this invention.

FIG. 3 is an illustration depicting another exemplary method.

FIG. 4 is an illustration depicting another exemplary method.

FIG. 5 is an illustration depicting another exemplary method.

FIG. 6 is an illustration depicting another exemplary method.

FIG. 7 is an illustration depicting a span of the various exemplary methods.

### DETAILED DESCRIPTION

The invention will now be described with reference to the drawing figures, in which like reference numerals refer to like parts throughout. Various embodiments in accordance with the present invention provide enhanced entertainment/information dissemination to consumers by coupling the entertainment/information to a targeted event or scenario via the use of a pre-configured, fixed-content portable player, whereby the value presented by the entertainment/information can be substantially increased.

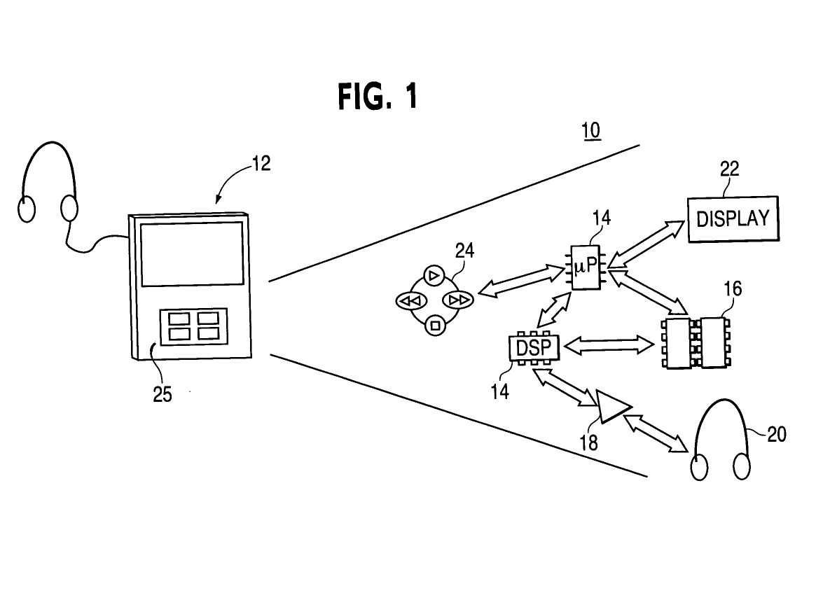

An illustration 10 of an exemplary player 12 suitable for use in the various exemplary methods described herein is illustrated in FIG. 1. The exemplary player 12 is illustrated as a personal, portable media player 12 having digitally encapsulated fixed content therein. The player 12 is configured with a microprocessor/digital signal processor (DSP) 14 for processing and converting the digital content contained in memory 16 for amplification by amplifier 18. The digital content may be in compressed form, according to any one or more of now known or future compression schemes, such as, for example, MPEG, WMA, AAC, etc. The amplified content stream is conveyed to headphones 20 for aural presentation and to display 22 for visual presentation to the user. The operation of the player 12 is controlled by a user input interface 24. The user input interface 24 can contain any one or more volume control, equalizer control, fast forward, skip, pause, reverse, and other features common to controlling a media playing device. An enclosure or “skin” 25 encompasses the player 12. The skin 25, in addition to providing an enclosure for the player 12, may be configured to with a design for visual branding of elements tied to the content in the memory 16 or to a third-party. The configuration of the skin 25 may comprise a design and/or a shaping of the form of the enclosure. For example, the skin 25 may be shaped in the form of Mickey Mouse ears to convey a Disney-related content in the player 12.

Additional modifications may be made to the exemplary player 12, without departing from the spirit and scope of the invention. For example, portions of the user interface 24 may be attached to the headphones 20, to enable a user to control the player 12, or the headphones 20 may be of a wired variety or non-wired, comprising one or more speaker elements. Additionally, the headphones 20 may be integrally attached to the player 12, so as to prevent removal from the player 12, or as seen in conventional player systems, removably attached. In removably attached systems, the player's headphone jack (not shown) may be connected to a home stereo or other systems to enable the user to enjoy the content using speakers or amplifiers other than that of the player's.

Additional modifications can be made, such as, modifications to the skin or exterior of the player 12 to enable easier “wearablity” of the player 12. For example, a ring or hole in the skin of the player 12 can be accommodated to facilitate a lanyard, a clip, etc., to enable attachment to a user's person. As is apparent, common or non-common features providing increased functionalities and attributes to the player 12 may be implemented, as according to design preference.

The content encapsulated in memory 16 is bound to the player 12 in that the memory 16 is non-re-recordable by the user/consumer. The content may be of any form of digital audio, video, audio/video, multimedia, textual, graphical, etc., or any combination thereof. The player 12 is designed to where the content contained in memory 16 is fixed and non-replaceable, once the content has been loaded into the memory 16. That is, the content is pre-loaded into the memory 16 prior to the user's receipt and, thus cannot be manipulated, overwritten, re-recorded by the user. The memory 16 may be any one of current or future memory systems which facilitate the storing of digital information and, therefore, is not limited to integrated circuits, Secure Digital (SD), Memory Stick®, Compact Flash, etc. Thus, any medium capable of storing digital information, whether electrical in nature or not, may be used in the player 12. The memory 16, therefore, may be separate from the player 12, having content pre-loaded therein and, thereafter, loaded into the player 12, either during the player's 12 assembly or prior to distribution to a user. Alternatively, the memory 16 may be integrated into the player 12 and then pre-loaded with content, wherein the content is fixed in the memory 16 so as to be non-rerecordable.

It should be appreciated that, based on the type of digital content or information contained in the memory 16, the microprocessor/DSP 14 may perform decompression or de-encryption of the stored digital information, as needed. While FIG. 1 illustrates the microprocessor/DSP 14 as separate entities, it is well known that chip sets are available that provide a unitary microprocessor/DSP unit. Further, it is known that DSPs having microprocessors built-in may negate the necessity for a separate microprocessor. Similarly, microprocessors having built in DSP capabilities may negate the necessity for a separate DSP unit. Accordingly, more or less circuits, devices, or elements may be used to achieve the desired function.

In one aspect of the invention, a data bus (not shown) is optionally provided for external communication. However, to retain the non-re-recordable constraint upon the player 12, the external bus is only capable of inputting content for storage into the memory 16, and not outputting the stored content. Thus, the exemplary player 12 may have its memory 16 loaded by connecting the exemplary player 12 to a content loading device, however, once the content is loaded onto memory 16, extraction or copying of the content to an external device is defeated.

It should be appreciated that, upon processing the digital information or content from the memory 16, a conversion from a digital format to an analog format may be accomplished by the use of digital-to-analog (D/A) converters (not shown). The D/A converters may be implemented between the microprocessor/DSP 14 unit and the amplifier 18. Alternatively, the D/A may be situated between the amplifier 18 and the headphones 20 and/or the display 22. All of the above elements described are powered as needed by a battery or alternative power source, such as a fuel cell (not shown).

Based on the exemplary player 12, a user upon purchase or acquisition of the exemplary player 12, can immediately enjoy or access the content in the player 12. Thus, the exemplary player 12 provides an “un-wrap and play” functionality. Moreover, since the content in the player 12 is fixed and non-rerecordable, content providers and sponsors of the content/player/skin advertisements do not need to fear wholesale copying of the content, as the content is only accessible via the headphones 20. In view of this, various exemplary implementations of the player 12 are illustrated in the following figures.

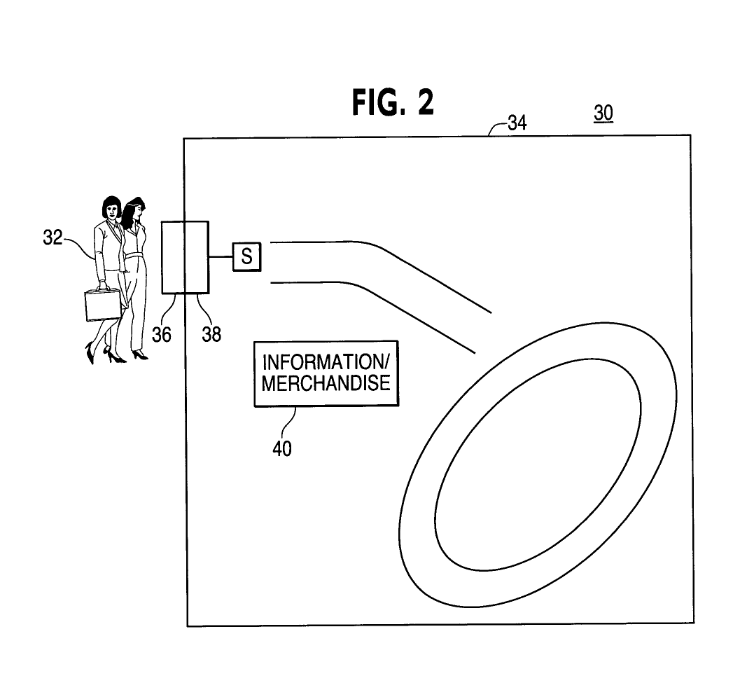

FIG. 2 is a depiction 30 of an exemplary player 12 used in an event or promotion. One or more participants 32, having agreed to a promotion or event (hereinafter, generically referred to as an “activity”), approach the bounds 34 of the activity and are presented with an exemplary 12 player either, exterior 36 to, or interior 38 to the boundary 34. For a ticketed event, the participants 32 may receive the exemplary player 12 at an interior 38 dissemination point S. Upon receipt of the exemplary player 12, the participants 32 will turn on the player 12 and enjoy the music, entertainment, or features provided by the player 12.

The exterior of the player 12 can be tailored for the activity, such as, for example, a NASCAR event where a racer's image or his race car can be imprinted on the exterior of the player 12. Statistics, music, biographical data, video clips, sponsors of the racer, etc. can be contained in the player 12 and viewed/listened to by the participants 32.

Customarily, such information would be provided to the participants 32 in the form of a brochure or magazine for promoting interest in the activity. These promotional materials are typically created in bulk and are not tailored to the specific interests of the participants 32. However, many participants 32 are more amenable to visual or aural stimulation, than to reading a brochure or magazine. By utilizing digital content specifically tailored or selectable by the participants 32, an enhanced activity experience can be acquired by the participants 32. Accordingly, sponsors of the activity can tailor their advertising to result in a higher return on investment.

For example, the participants 32 may have an interest in a particular race driver at the NASCAR activity. Having selected a exemplary player 12 with the race car driver's image or information imprinted on the player 12, the participants 32 can be entertained or informed of certain exploits of the driver. Alternatively, during the race, the participants 32 may wish to review a fact or image previously viewed or listened to in the player 12 by manipulating the user interface 24. Based on information garnered from the playing of the player 12, the participants 32 may desire to seek a souvenir or purchase memorabilia/items, for example, from a merchandising booth 40. Thus, the sponsors of the activity can solicit a higher income stream from the participants 32, than previously known.

The participants 32 may be offered the opportunity to exchange their selected player 12 for another player 12 having the image or likeness of a different driver, for example. The easy exchange of a such a player 12 and the convenience of communicating entertainment/information to the participant 32 via a portable media/audio forum enhances the participants' 32 activity experience.

Further, these players 12 can be considered as souvenirs of the activity and may facilitate a secondary market in memorabilia. Specifically, the exterior of the player 12 may be altered to have more than an image, that is, the shape and configuration of various players 12 may be configured with different race cars or a racers' images. Thus, by altering the appearance and shape of the player 12, the collectibility of the players 12 can result in an increased source of enjoyment for the participants 32. Accordingly, upon receipt of the player 12, a secondary market in the trading and exchange of these players 12 can be created. As such, trading, as commonly seen with baseball cards, can be facilitated though mechanisms created or managed by the sponsors, or by other third parties, such as auctions, fan clubs, etc.

In various exemplary embodiments described herein, the players 12 and/or attendant materials for the activity may be a priori mailed to or picked up by the participants 32 prior to attending the activity. For example, activity tickets that are mailed to the participants 32 may be mailed with a player 12 enclosed. Thus, the participants 32 can be exposed to promotional or advertising information well prior to the attendance of the activity and, thereby, become more amenable to purchasing souvenirs while attending the activity. It should be appreciated that by enabling the participants 32 to “pre-view” the content provided in the player 12, the participants 32 may wish to purchase items from a website, local store or other commercial venue, or obtain additional information provided by the activity or sponsor, due to the information provided by the player 12.

It should also be appreciated that while FIG. 2 is discussed in the context of a NASCAR event, the exemplary player 12 may be suitable for other types of events. For example, an opera management company may forward a set of purchased tickets with an exemplary player 12, containing short arias of performances by the cast. Other examples are promotional events and sponsors thereof which may provide appropriately configured players 12 to their audience. Conferences or large exhibits are well suited for such a player 12. In a multi-venue activity, patrons, not having yet decided which performance to purchase, may be able to sample various acts of the multi-venue while waiting in line.

It should also be appreciated that while the exemplary method of FIG. 2 is discussed in the context of “events,” other circumstances that are non-event related are well-suited for use of such an exemplary player 12. Therefore, alternative uses and schemes for distributing media content within the exemplary player 12 that are non-event related are understood to be within the spirit and scope of this invention.

Due to the encapsulated and non-rerecordable content of the players 12, the sponsors of the activity, supplying the players 12, do not need to be concerned with theft or copyright violation of the content housed within the player 12. Accordingly, artists and entertainment industries will be more willing to engage in the exchange of their creations for marketing or advertising purposes, due to the inherent protection provided by the players 12.

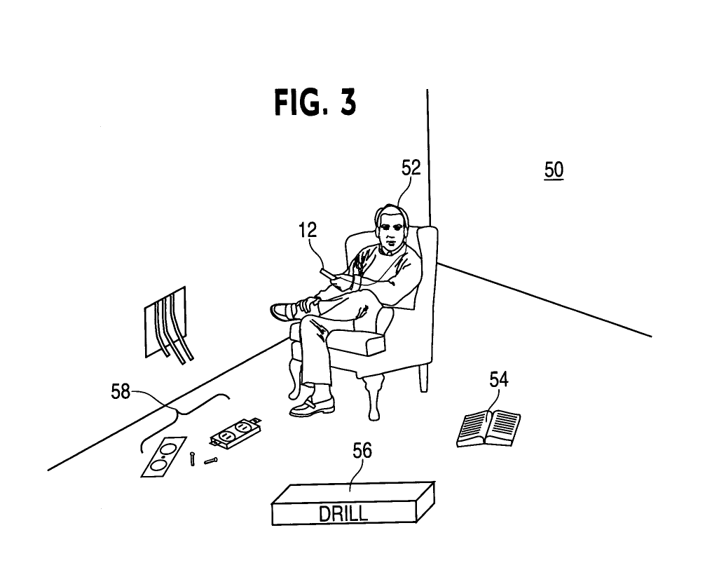

FIG. 3 is an illustration 50 depicting another exemplary use of an exemplary player 12. FIG. 3 illustrates a consumer 52 listening to an instructional program provided by the player 12. The player 12 may be bundled with an instructional “how-to” book 54 for home repair, for example. Alternatively, the player may be supplied with a tool 56 purchased by the consumer 52. In the illustration 50 of FIG. 3, a project of replacing a wall receptacle 58 is shown as one example, wherein the use of the player 12 is facilitated. The player 12 can be configured with an audio capability and/or video capability.

As is well known in the industry, various portions of the population are not well suited to reading difficult or hard to understand instructions, as language barriers may present a problem for many. Also, physically handicapped members of the population that are well suited for such a player 12, is the hard-of-seeing or blind community.

It is also understood that are static pictorial diagrams are not suitable for illustrating the complex progression of steps necessary for completing a difficult project, such as, a home repair project. The capability provided by the player 12 in a home repair project is in some ways similar to that provided by an instructional video tape or DVD regarding the home repair. However, unlike conventional videos, the necessity for an expensive audio/video player can be supplanted by a simple, inexpensive portable player 12. Furthermore, the small form factor and self-powered capability of the player 12 enables the consumer 52 to view or listen to the steps of performing a repair without requiring external power or bulky presence as required in a conventional VHS/DVD player unit. Thus, the exemplary player 12 enables instructional information to be readily and easily conveyed to the consumer 52, and also enables instruction to the consumer 52 in outdoor environments or locations not having capabilities for supporting a VHS/DVD player.

Other advantages of the player 12 that become readily apparent upon understanding the inventive concepts described herein, are the protectibility of the media housing the content. That is, DVDs and VHS tapes are notorious for easily being damaged. It is well known that the surfaces of a DVD disk can be scratched, therefore, rendering the viewing program to be unviewable. Similarly, VHS tapes are not well suited for extensive playbacks due to the inferior quality of tape use therein. Due to the fact that the digital content is securely fixed in the memory of the player 12 and not exposed to any damaging external physical forces, the consumer 52 need not be concerned with “scratching” or “jamming” the content stored therein. Moreover, as alluded in the description provided in FIG. 2, the player 12 may be formed to have a particular shape to help associate the player's 12 content with the bundled product. For example, the player 12 may be formed having an outline of a drill, or a saw, for example, thus enabling “quick” retrieval from a library of players 12.

It should be appreciated, of course, that the player 12 may be used for other purposes, than simply for facilitating home repair. For example, with a player 12 configured with a specific shape, identification of the player 12 (and its associated content) by visually impaired people can be expedited, as compared to conventional media which are not identifiable by a shape (standard DVD, cassette, etc.). Other non-limiting examples include hobby building, operational instruction sheets (OIS), manual-replacement, office equipment repair, education, computer repair, emergency auto repair, medical information (e.g., diabetes self-injections), multi-language instructions for foreign shipped products, etc.

Thus, one of ordinary skill, upon understanding the inventive concepts and methods described herein, will understand that there are a plethora of opportunities for using such a player 12 which span education, instructional, entertainment, etc. and, therefore, should not be limited solely to the instructional aspects of FIG. 3, or other examples described herein.

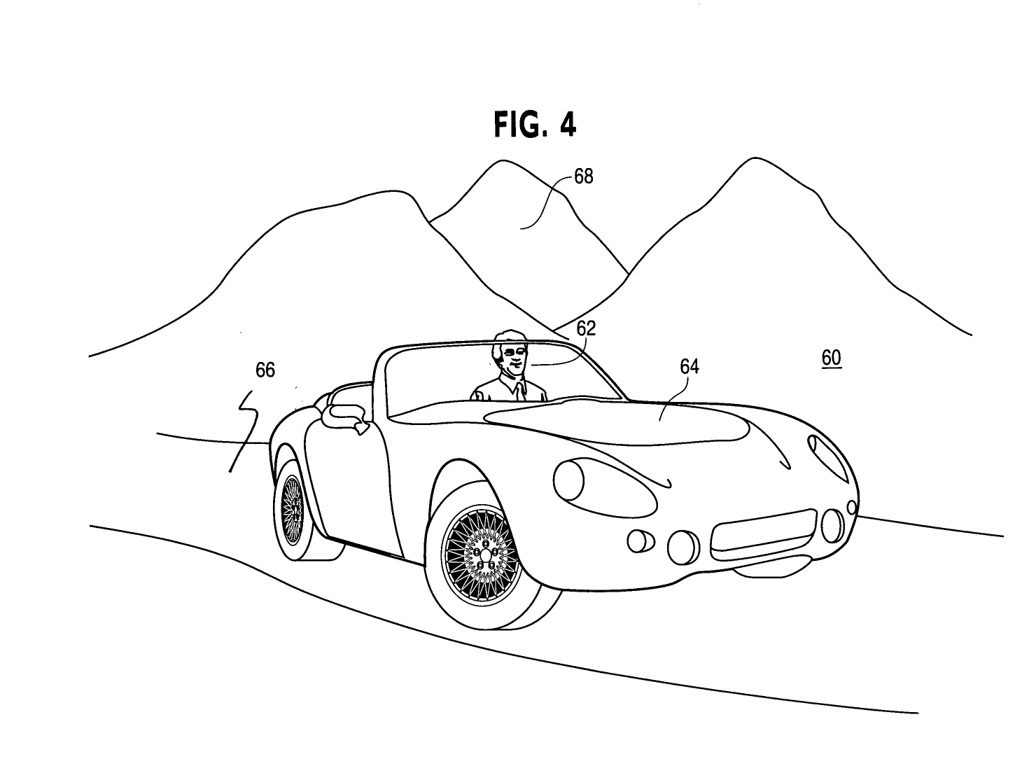

FIG. 4 is an illustration 60 depicting another exemplary method for using an exemplary player. FIG. 4 illustrates a driver 62 having a player (not shown) driving a vehicle 64 on a highway 66. The player can be imprinted with travel information for providing tourists or attraction-related information for the driver 62. For example, the scenery 68 may have historical significance which is explained to the driver 62, by the player. Sponsors of such use of a player may be any of numerous enterprises, such as, restaurants or businesses, etc. along the driver's 62 route or attractions therein. Due to the small form factor provided by the player, when the driver 62 stops at a desired attraction, the driver 62 can be accompanied with the player throughout the attraction. For example, at scenic or historic attractions, the driver 62 may exit his vehicle 64 and peruse the attraction guided by information provided by the player. Accordingly, restaurants, hotels, facilities bordering scenic sites or attractions are provided with an alternative form of personalized advertising herethereto unknown in the art.

Due to the self-contained nature of the player, the driver 62 is not required to purchase a separate and, presumably, expensive player. Additionally, unlike prior art approaches utilizing a tape or CD (which cannot be played separate from the vehicle), the enterprises/businesses wishing to exploit this exemplary capability do not need to be concerned as to whether the customer's vehicle is equipped with a “radio unit” that is capable of playing a tape versus a CD. Accordingly, the exemplary player may be conveniently provided by any one of numerous travel related entities, such as, for example, the American Automobile Association® or American Express® as part of their travel promotions or programs.

It should be appreciated that, notwithstanding the tourist-related context discussed in FIG. 4, non-tourist-related uses and methods for the exemplary player are possible. For example, the driver 62 may have an exemplary player with any one or more of language lessons, motivational lessons, story-books, self-health, etc., according to market demand or driver 62 interest. Thus, variations can be made on the content and, accordingly, the use for an exemplary player configured with such content without departing from the spirit and scope of this invention.

Additionally, while FIG. 4 is described in the context of the driver 62 being the user of the player 12, it should be appreciated that other members (not shown) or passengers may use the player 12, or other forms of transportation (e.g., airplane, train, bus, etc.) may be used without departing from the spirit and scope of this invention. As an illustrative example, the user may be an airplane traveler traveling to a foreign country wishing to select a player 12 having a language or “highlights of the destination” content. Therefore, books, movies, school lessons, etc., that may be of value to the user can be more readily used by the traveler.

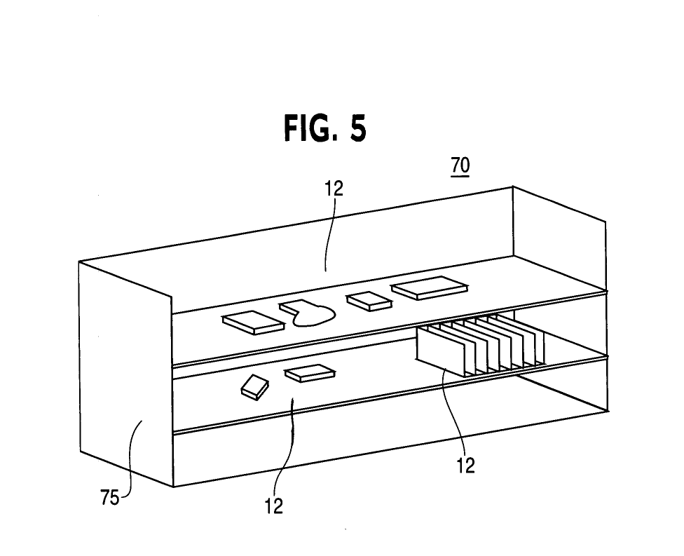

FIG. 5 is an illustration 70 depicting another exemplary use of the exemplary player 12 in disseminating content related to entertainment. It is well appreciated in the recording and music industry that copyright protection, in view of the easy reproducibility of digitally recorded music, is of grave concern within the industry. Presumably, all of the concerns of this industry can be alleviated by encapsulating the digital content of the music/video into an non-rerecordable medium placed within a self-contained portable player 12. Thus, the standard paradigm for music or video stores to provide content by only relying on encryption techniques to protect the content, can be supplanted by a distribution scheme that bundles a fixed content into an inexpensive player 12. Therefore, the only mechanism for “extracting” the content from the player 12 is through the actual playing of the music. Since the playing of the music transforms the digital content into a “less desirable” analog form, wholesale copying of the content is discouraged.

As depicted in FIG. 5, audio and/or video content is encapsulated in a series of exemplary players 12 exhibited in a display 75 for purchase or rental by consumers. Similar to the layouts provided in music stores, the exemplary players 12 with their respective content can be categorized by artist, genre of entertainment, alphabetically, etc. Accordingly, conventional approaches to selling music and/or video entertainment can be applied to provide the same service to the customer using the exemplary players 12, rather than a CD or media.

It should be appreciated that while the exemplary process described in FIG. 5 is elucidated in the context of distributing music or videos, other forms of content may be similarly distributed. For example, the store may be a book store, which may have a similar arrangement for displaying books, instructional books, children's books, greeting cards, as well as actual speeches.

Though FIG. 5 illustrates a typical scheme for marketing and/or retail distribution of digitally encapsulated content bundled with an exemplary player 12, it should be appreciated that alternative schemes for distribution and/or retailing may be used. For example, a vending machine type environment wherein the customer selects a media player 12, according to its content or appearance can be utilized. As alluded in the description of FIG. 1, the exemplary players 12 may have varying forms, styles, external appearances, as selectable by the consumer. Therefore, a display 75 as described in FIG. 5 may have several different player 12 appearances for the same content. Along this line, it is conceived that a vending machine or similarly functioning device can be configured to enable a customer to pick and select an exemplary media player 12 having desired content and external appearance. Thus, a significant degree of customization is afforded to the consumer that thereto has not been available. Of course, based on the description provided herein, one of ordinary skill in the art may modify or make changes to how the player 12 is presented or distributed without departing from the spirit and scope of this invention.

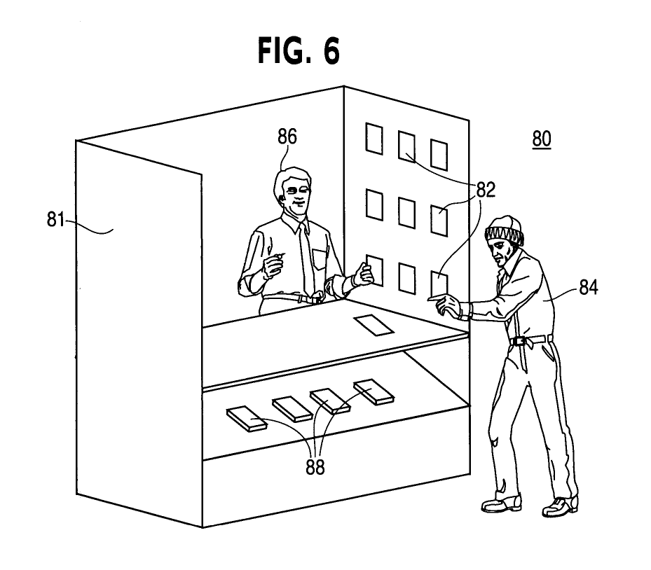

FIG. 6 is an illustration 80 depicting another exemplary method for disseminating the exemplary player 12. FIG. 6 illustrates a kiosk 81 containing a selection of various exemplary players 12 having a casing 82 absent the digital content. That is, rather than having the exemplary players 12 prepackaged with a particularly genre or type of entertainment, the players 12 are “unloaded” and content-free. Therefore, customer 84, not unlike shopping for a cell phone, can select a particular model/casing 82 of media player 12 suitable to the customer's 84 taste and thereafter request the vendor 86 to load it with the desired selection of content, illustrated here as a digitally storage media 88. However, in conformity with the general tenets of this invention, upon loading the storage media 88 into a selected player 12, the media 88 is prevented from being subsequently removed from the player 12. The ability to secure the media 88 and thus the content in the player 12 can be accomplished by utilizing a one-way mechanical latch in the player 12. Alternatively, an electrical fuse or coding/lock-out scheme can be implanted in the storage media 88, preventing removal of the storage media 88 from the player 12 without incapacitating the content stored on the media 88.

It should be appreciated that there are numerous alternative schemes for fixing the storage media 88 into the casing 82 to form a player 12, so as to prevent removal of the storage media 88 from the player 12 upon initial configuration of the exemplary player 12. Therefore, alternative schemes for accomplishing the above “binding” of the digital content to the player 12 are within the scope of one of ordinary skill in the art and, therefore, are not detailed herein.

Utilizing the exemplary process demonstrated in the illustration 80 of FIG. 6, consumers 84 can devise a degree customization of their player 12. For example, various exemplary players 12 may have different external skins or functional features which are preferred by the customer 84. Based on a preferred selection by the customer 84, the customer 84 can select anyone of the available content, which is digitally stored in media 88, for the customer's 84 enjoyment. Additionally, various exemplary players 12 may be differentiated from other exemplary players 12 in their capabilities, such as, for example, capacity, durability, power life, quality of viewing, stereophonic features (e.g., equalizer, etc.), compactness, color, etc.

Thus, similar to the benefits discussed in FIG. 5, regarding the music/entertainment industry's concern for unauthorized copying, the exemplary method illustrated FIG. 6 provides the same degree of protection while enabling the customer 84 the ability to enhance his purchasing decision by choosing a desired player 12 type or form. Accordingly, while the exemplary process of FIG. 6 initially has the digital content separate from the player 12, upon purchase by the customer 84, the digital content and the player 12 are finally sold as a single product.

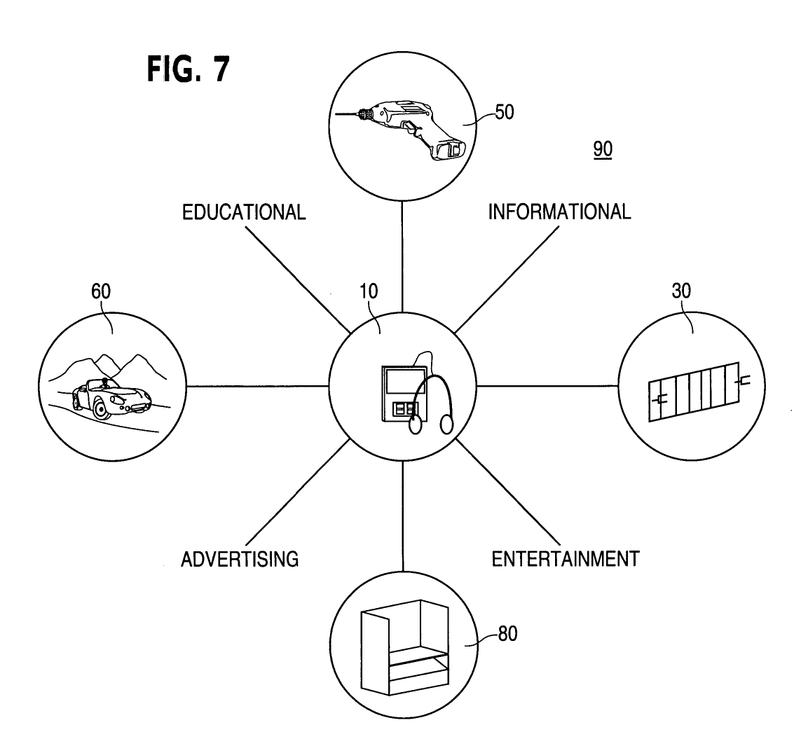

FIG. 7 is a diagram 90 illustrating various attributes of the exemplary methods spanning several fields generically titled “activities” 30, “education” 50, “information” 60, and “entertainment” 80. By use of a portable media player 12, having a fixed, non-removable content therein, all of these fields, as well as other fields amenable to the use of such a player 12, can be exploited in a manner hereunto unknown in the prior art. By coupling the marketed content with a portable, personal player, and also ensuring the non-removability of the content from the player, sponsoring parties can provide very cost-effective methods for enhancing the user/customer's experience in any desired field of enterprise, while reducing the concern for wholesale theft or duplication of the content in the player. Thus, there is an increased incentive for the creators of the content to license or provide their creations for use by the sponsors.

Further, due to the player's 12 ability to be “instantly” turned on (i.e., in contrast to the user bringing their own player and then installing/loading the content into the player), immediate access to the content, as well as an increased probability that the user will play the content within the sponsor's targeted venue, is made feasible. Accordingly, as a consequence of the “focusing” of the player's content/skin with the targeted venue, the sponsor is afforded a higher “return” than conventional approaches.

As should be appreciated, FIG. 7's diagram is provided to demonstrate exemplary products and experiences that can be enhanced by use of an exemplary player, as described herein. Therefore, the fields of use shown in FIG. 7 are exemplary and other fields, products, venues, etc. may be used as deemed appropriate.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of distributing content, comprising the steps of:
storing the content in a digitized format in a fixed memory of a portable, self-contained, playback-only media player, wherein the memory is non-consumer recordable and the digitized content is non-transferable from the player.

2. The method according to claim 1, wherein the digitized content is electronically stored in the fixed memory.

3. The method according to claim 1, further comprising the step of:
bundling a non-removable headphone with the media player.

4. The method according to claim 1, further comprising the step of:
providing playback control with the media player.

5. The method according to claim 1, further comprising the step of:
providing a video screen in the player.

6. The method according to claim 1, further comprising the step of:
providing a replaceable power source in the player.

7. The method according to claim 6, wherein the power source is a fuel cell.

8. The method according to claim 1, wherein the content is audio content.

9. The method according to claim 8, wherein the audio content is spoken word.

10. The method according to claim 8, wherein the audio content is an audio book.

11. The method according to claim 8, wherein the audio content is music.

12. The method according to claim 5, wherein the content is video content.

13. The method according to claim 12, wherein the content is at least one of audio and visual.

14. The method according to claim 12, wherein the video content is a movie.

15. The method according to claim 12, wherein the video content is a music video.

16. The method according to claim 1, wherein the content is entertainment.

17. The method according to claim 1, further comprising the step of:
placing an image related to the content on an exterior of the media player.

18. The method according to claim 1, wherein an advertisement is placed in the content.

19. The method according to claim 18, wherein an image related to the content is placed on an exterior of the media player, and the advertisement is related to the content.

20. The method according to claim 1, further comprising the step of:
conforming an exterior shape of the media player to relate to the content.

21. The method according to claim 1, further comprising the step of:
distributing the digitized content in the media player to at least one or more consumers.

22. The method according to claim 21, wherein the step of storing includes downloading the digitized content into the memory, prior to distributing the media player to the consumer.

23. The method according to claim 21, further comprising the step of:
establishing a forum to enable consumers with players to barter their players.

24. A method of distributing content, comprising the steps of:
sponsoring an activity which solicits at least one or more attendees; and
distributing the content to an attendee in a portable, self-contained, playback-only media player, wherein the content is digitally stored in a fixed memory of the player, and the memory is non-consumer recordable, and the digitized content is non-transferable from the player.

25. The method according to claim 24, wherein the digitized content is electronically stored in the fixed memory.

26. The method according to claim 24, further comprising the step of:
bundling a non-removable headphone with the media player.

27. The method according to claim 24, further comprising the step of:
providing playback control with the media player.

28. The method according to claim 24, further comprising the step of:
providing a video screen in the player.

29. The method according to claim 24, further comprising the step of:
providing a replaceable power source in the player.

30. The method according to claim 29, wherein the power source is a fuel cell.

31. The method according to claim 24, wherein the content is audio content.

32. The method according to claim 30, wherein the content is an audio book.

33. The method according to claim 24, wherein the content is video content.

34. The method according to claim 24, wherein the content is audio-visual content.

35. The method according to claim 24, wherein the content is related to the activity.

36. The method according to claim 24, wherein the content is entertainment.

37. The method according to claim 24, further comprising the step of:
binding an activity-related image to an exterior of the media player.

38. The method according to claim 24, wherein an advertisement is placed in the content.

39. The method according to claim 38, wherein the advertisement is related to the content, and an image related to the activity is placed on an exterior of the media player.

40. The method according to claim 24, further comprising the step of:
conforming a shape of the media player to an activity-related image.

41. The method according to claim 24, further comprising the step of:
establishing a forum to enable attendees with players to barter their players.

42. A method of distributing content, comprising the steps of:
providing a product;
bundling with the product a portable, self-contained, playback-only media player, containing product-related content digitally stored in a fixed memory of the player, wherein the memory is non-consumer recordable, and the digitized content is non-transferable from the player.

43. The method according to claim 42, further comprising:
binding an image of the product to an exterior of the media player.

44. The method according to claim 42, further comprising:
conforming a shape of the media player to relate to the product.

45. The method according to claim 42, wherein the digitized content is electronically stored in the fixed memory.

46. The method according to claim 42, further comprising the step of:
bundling a non-removable headphone with the media player.

47. The method according to claim 42, further comprising the step of:
providing playback control with the media player.

48. The method according to claim 42, further comprising the step of:
providing a video screen in the player.

49. The method according to claim 42, further comprising the step of:
providing a replaceable power source in the player.

50. The method according to claim 42, wherein the power source is a fuel cell.

51. The method according to claim 42, wherein the content is information relating to the product.

52. The method according to claim 51, wherein the information is instructional and relates to a use of the product.

53. The method according to claim 42, wherein the product is a service.

54. The method according to claim 42, wherein the product is medically related.

55. The method according to claim 42, wherein the product is computer related.

56. The method according to claim 42, wherein the product is mechanically related.

57. A method of distributing content, comprising the steps of:
displaying a portable, self-contained, playback-only media player, containing content stored in a digitized format in a fixed memory of the player, wherein the memory is non-consumer recordable, and the digitized content is non-transferable from the player; and
at least renting or selling the player to a consumer.

58. The method according to claim 57, wherein the digitized content is electronically stored in the fixed memory.

59. The method according to claim 57, further comprising the step of:
bundling a non-removable headphone with the media player.

60. The method according to claim 57, further comprising the step of:
providing playback control with the media player.

61. The method according to claim 57, further comprising the step of:
providing a video screen in the player.

62. The method according to claim 57, further comprising the step of:
providing a replaceable power source in the player.

63. The method according to claim 62, wherein the power source is a fuel cell.

64. The method according to claim 57, wherein the content is audio content.

65. The method according to claim 57, wherein the audio content is spoken word.

66. The method according to claim 64, wherein the audio content is music.

67. The method according to claim 64, wherein the audio content is an audio book.

68. The method according to claim 57, wherein the content is video content.

69. The method according to claim 68, wherein the video content is a movie.

70. The method according to claim 68, wherein the video content is a music video.

71. The method according to claim 57, further comprising the step of:
placing an image related to the content on an exterior of the media player.

72. The method according to claim 57, wherein an advertisement is placed in the content.

73. The method according to claim 72, wherein the advertisement is related to the content, and an image related to the content is placed on an exterior of the media player.

74. The method according to claim 57, further comprising the step of:
conforming an exterior shape of the media player to relate to the content.

75. The method according to claim 57, further comprising the step of:
loading the digitized content into the memory, prior to the at least renting or selling the player to the consumer.

76. The method according to claim 57, wherein the content is instructional.

77. The method according to claim 57, wherein the content is informational.

78. The method according to claim 57, wherein the content is educational.

79. The method according to claim 57, wherein the content is promotional.

80. The method according to claim 57, wherein the content is sports-related.

81. The method according to claim 57, wherein the content is entertainment-related.
